(19) United States
(12) Patent Application Publication
(10) Pub. No.: US 2016/0128317 A1
(43) Pub. Date: May 12, 2016

(54) ASSISTIVE APPARATUS FOR HANGING A TREE STAND

(71) Applicant: Theodore Robert Gerry, Merrimac, WI (US)

(72) Inventor: Theodore Robert Gerry, Merrimac, WI (US)

(21) Appl. No.: 14/932,437

(22) Filed: Nov. 4, 2015

Related U.S. Application Data
(60) Provisional application No. 62/076,661, filed on Nov. 7, 2014.

(51) Int. Cl. A01M 31/02; A45F 3/26

(52) U.S. Cl. CPC A01M 31/02; A45F 3/26

(57) ABSTRACT

An assistive apparatus for hanging a tree stand (e.g., in a tree) including a base pivotably mounting a pair of opposable arms, and a pair of springs for moving the arms between open, spaced apart set positions and closed tree clamping positions clamping a tree or pole there-between. A pair of trigger members operatively coupled to the arms react to a tree or pole being pushed there against to release the arms from their open, spaced apart positions to closed tree clamping positions.

This application claims priority to U.S. Provisional Application No. 62/076,661 filed Nov. 7, 2014 entitled “Tree Hugger,” the contents of which are hereby incorporated by reference in their entirety.

### FIELD

The present inventions relate to the field of stands used by hunters, wildlife observers, photographers, and the like. The present inventions more specifically relate to the field of apparatus and methods for use in hanging such stands.

### BACKGROUND

Tree stands offer numerous advantages to hunters, photographers, nature watchers, etc. For example, known tree stands give hunters a longer range of visibility and allow more time to prepare for a safe shot at game. In addition, tree stands improve the hunter's chances of seeing game animals. In a tree stand, a hunter can move without being easily detected by game and the hunter's scent can remain in the canopy of the trees instead of on the ground where it can give away the hunter's position to nearly game. In addition, shots taken by a hunter from a tree stand are typically at a downward angle, making the ground the backdrop for a stray bullet or arrowhead. In addition, blaze orange can be seen at greater distances in the tree stand than on the ground where a hunter's blaze orange colors might be blocked by brush and debris.

Tree stands come in a variety of types, including climbing stands, ladder stands and hang-on stands. Hang-on stands tend to be considered the most versatile and popular of the stand type because they allow hunters to ascend trees quickly and quietly during hunting.

With tree stands such as hang-on stands, however, come a variety of issues and serious risks. One of the issues faced by hunters using a tree stand, and especially a hang-on stand, is the installation of the stand in the tree. To install the stand, a hunter will typically utilize screw in steps or a ladder to ascend to the point on the tree at which the hunter intends to install the stand. It is often recommended that the hunter installing the stand maintain three points of contact to the tree such as two feet and one hand or two hands and a foot but, it can be difficult to maintain three points of contact when installing the hang-on stand. The hunter is typically forced to attempt to install a stand with one arm wrapped around the tree, one leg wrapped around the tree and one foot on a ladder or step. Further, to help strap in the stand, the hunter will often need to release one or more of the points of contact to provide the strap around the tree and engage the strap to properly hang the stand.

Attempting to hang a stand from a height of a tree is considered by many to be the most dangerous part about being in a tree or utilizing a tree stand. Unfortunately, statistics show that tree stand accidents are currently the number cause of hunter related injuries every season. Statistics show that one in every three hunters hunting from a tree stand will fall from the tree at some point in their hunting career. Of those falls, a large percentage will occur while ascending or descending the tree. Moreover, as it might be expected, such falls lead to serious injuries. By some estimates, 80% of tree stand accident victims will require surgery, 60% will have fractures, 30% will have spinal fractures, and 10% will have permanent disabilities or paralysis.

In addition to difficulties and risks related to safety, current tree stands can be tedious to install. Typically, a hunter can attempt and fail many times at installing a tree stand due to the difficulties installing a tree stand while maintaining sufficient points of contact with the tree. In addition, the difficulty in installing a tree stand frequently results in mis-installation. For example, it is not unusual to have to install, uninstall, and reinstall tree stands to ultimately place them at the desired orientation relative to the tree and surroundings. For example, the torque associated with the installation of a tree stand can cause the tree stand to rotate or move around the tree to a less desirable or undesirable location.

Accordingly, there is a need for an apparatus that allows for a safer installation of tree stands. There is also a need for an apparatus and method that allows for a faster installation or tree stands. There is also a need for an apparatus and method that allows for installation of tree stands with less effort. In addition, there is a need for an apparatus and method that is inexpensive and can be used uniformly with many popular tree stands on the market currently or in the future. And, there is a need for the apparatus and method that can be used with existing or future tree stands without the use of additional straps or external hardware.

### SUMMARY

Accordingly, an assistive device and method for hanging a tree stand are provided.

The present disclosure relates to an apparatus and method for the safer installation of tree stands. In addition, the present disclosure relates to an apparatus and method for the installation of tree stands that require less effort by the installer and can be installed relatively faster. In addition, the present disclosure relates to an apparatus and method that allows the tree stand to be installed at a desired or preselected orientation and position relative to the tree without having to repeatedly and continually uninstall, reinstall and adjust the tree stand to reach the desired or preselected position. In addition, the present disclosure relates to an apparatus and method for installing a tree stand that is inexpensive and can be used universally with many popular and well known tree stand and tree stand brands.

The present disclosure relates to an apparatus for hanging a tree stand, the apparatus comprising: a base member adapted to be coupled to a tree stand; the base member having a first end and a second end; a first arm pivotably coupled near the first end of the base member; an oppositely disposed second arm coupled near the second end base member; a first actuation member operatively coupled to the base member and the first arm; a first trigger member pivotably coupled to the base member near the first end of the base member; and a first lock member coupled to the first trigger member, the first lock member comprising a lock component adapted to engage at least one locking feature of the first arm to help hold the first actuation member in tension as desired.

The present disclosure relates to an apparatus for hanging a tree stand, the apparatus comprising: a base member coupled to a means for holding a tree stand; the base member having a first end and a second end; a first arm pivotably coupled near the first end of the base member; a second arm coupled near the second end of the base member and oppositely disposed to the first arm; a means for rotating the first arm relative to the base member and toward the second arm, the means for rotating the first arm being operatively coupled to the first arm; and a means for triggering the means for rotating the first arm.

### BRIEF DESCRIPTION OF DRAWINGS

Various examples of embodiments of the systems, devices, and methods according to this invention will be described in detail, with reference to the following figures, wherein:

FIG. 1 illustrates an isometric view of an assistive apparatus for hanging a tree stand according to various examples of embodiments.

FIG. 2 illustrates a second isometric view of an apparatus for hanging a tree stand according to various examples of embodiments.

FIG. 3 illustrates a third isometric view of an apparatus for hanging a tree stand according to various examples of embodiments.

FIG. 4 is a top view of an apparatus for hanging a tree stand according to various examples of embodiments.

FIG. 5 is an isometric view of an actuated apparatus for hanging a tree stand according to various examples of embodiments.

FIG. 6 is a top view of an actuated apparatus for hanging a tree stand according to various examples of embodiments.

FIG. 7 illustrates an isometric view of an assisted apparatus for hanging a tree stand according to various examples of embodiments.

FIG. 8 illustrates a top view of an apparatus for hanging a tree stand according to various examples of embodiments.

FIG. 9 illustrates an isometric view of an apparatus for hanging a tree stand that is coupled to a tree stand according to various examples of embodiments.

FIG. 10 illustrates a top view of an actuated apparatus for hanging a tree stand engaging a tree according to various examples of embodiments.

FIG. 11 illustrates an isometric view of an actuated apparatus for hanging a tree stand that is coupled to a tree stand and engaging a tree according to various examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, various examples of an assistive apparatus 100, 500 and method are provided.

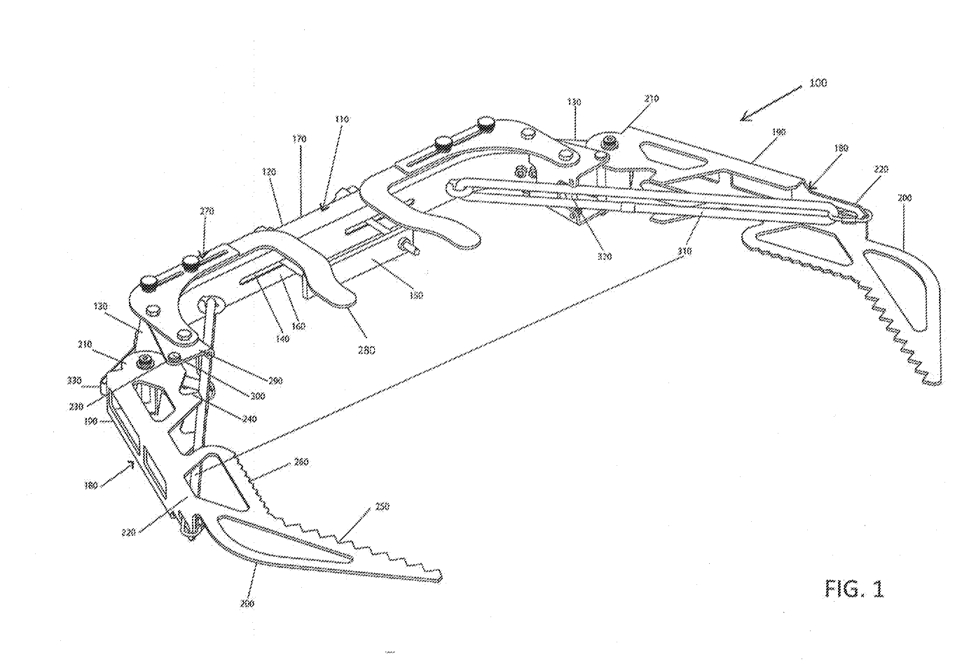

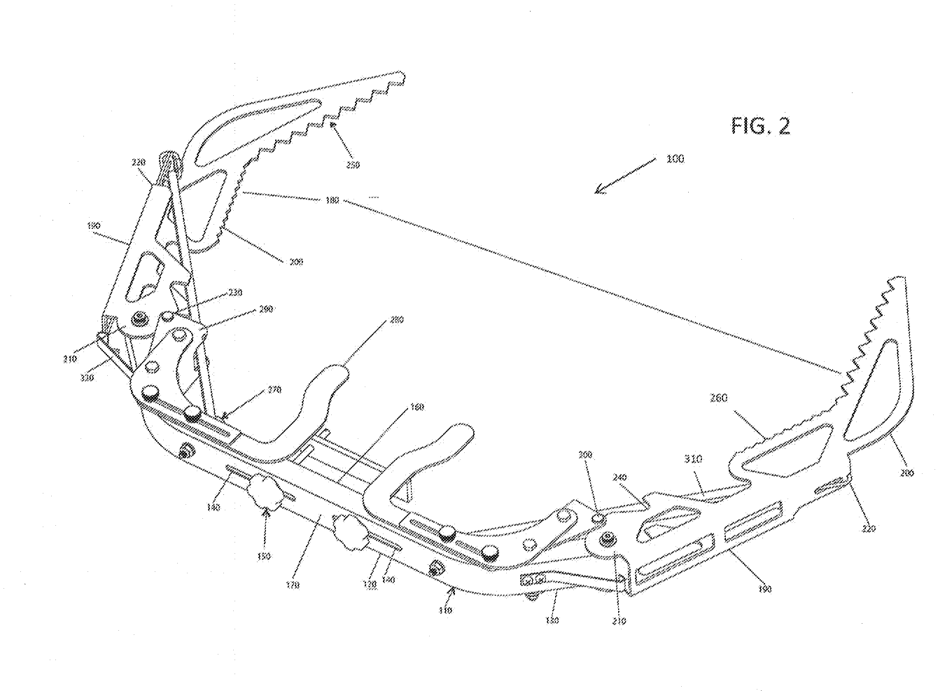

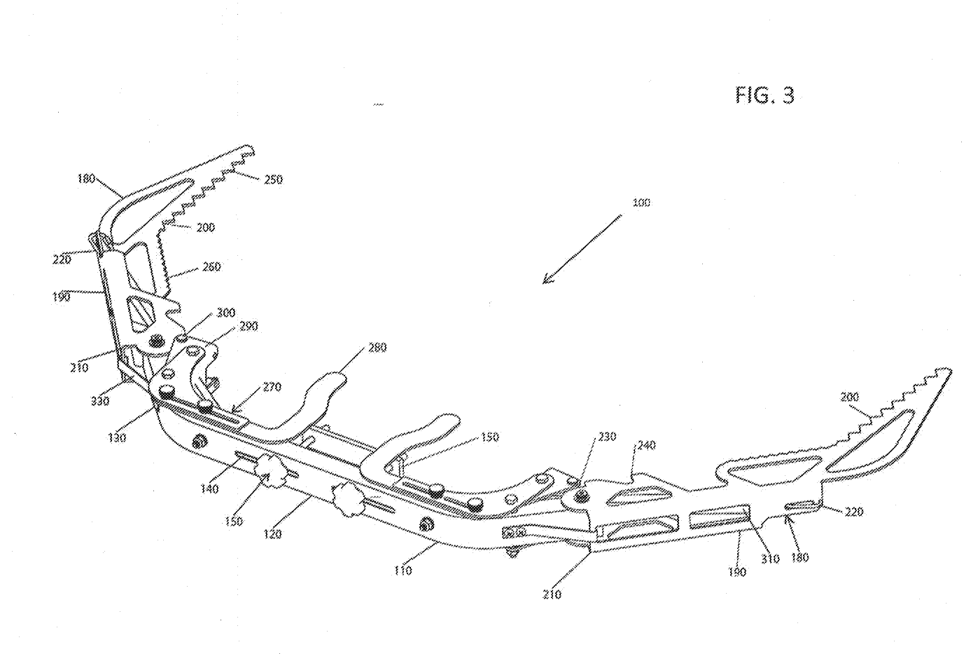

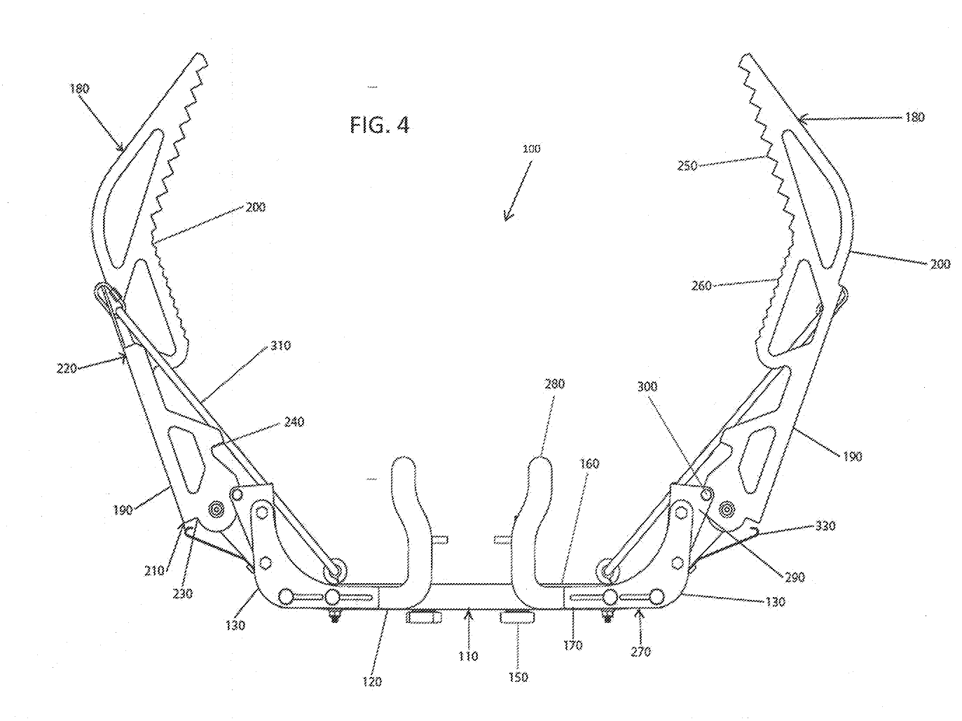

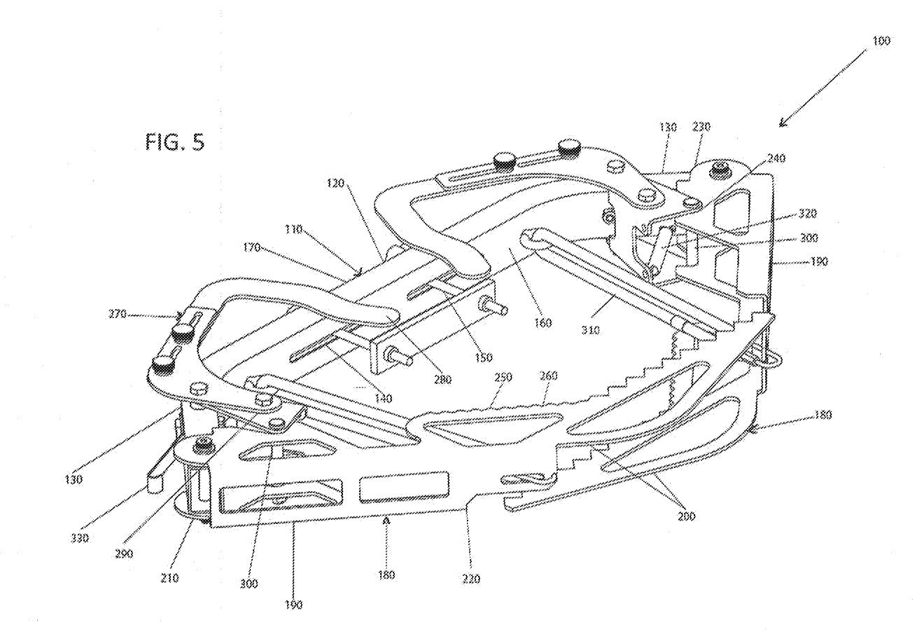

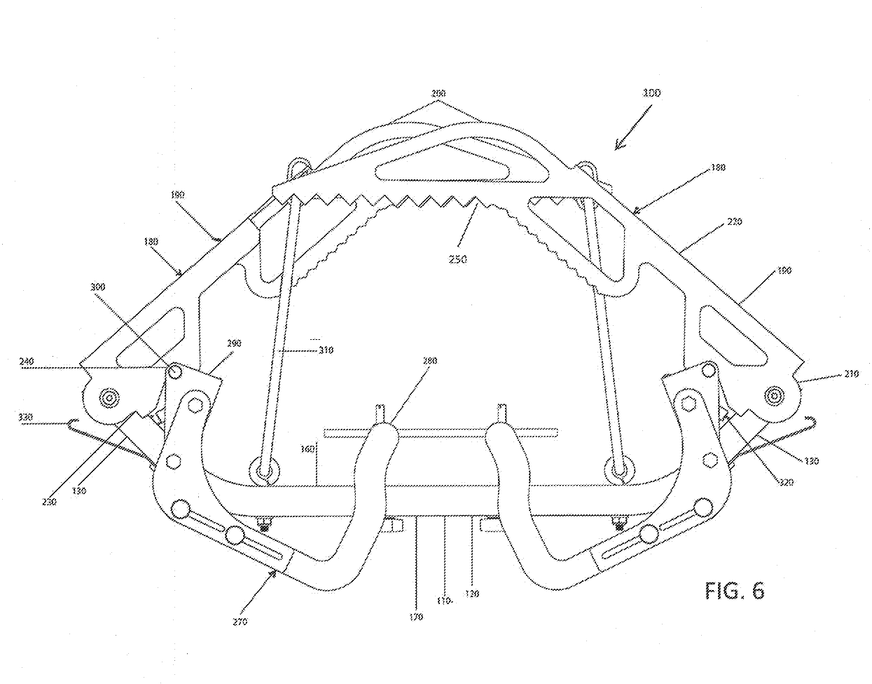

Referring to FIGS. 1-6, apparatus 100 includes a base member 110. In various embodiments, base member 110 includes a tree stand engagement section 120 between arm engagement sections 130. In various embodiments, tree stand engagement section 120 defines slots or apertures 140 through which one or more adjustable tree stand engagement clamp apparatus or components 150 may be provided. In various embodiments, apertures 140 are slots which allow adjustable tree stand engagement clamp apparatus 150 to be slid or adjusted within or relative to apertures 140 to allow the adjustable tree stand engagement clamp apparatus 150 to better fit, engage, and/or releasably engage or otherwise couple to a tree stand.

In various embodiments, base member 110 includes a tree side surface 160 and a field side surface 170. In various embodiments, apertures extend from field side surface 170 through base member 110 to tree side surface 160.

In various embodiments, arm engagement sections 130 angle away from a longitudinal axis of the stand engagement section 120 and toward tree side surface 160 of tree stand engagement section 120. However, it should be appreciated that, the arm engagement sections may be in a variety orientations relative to the tree stand engagement section. For example, the arm engagement sections and the tree stand engagement section may be aligned or co-linear.

In various embodiments, one or more arm engagement sections 130 are coupled to an opposable or oppositely disposed arm 180. In various embodiments, one or more opposable arms 180 are pivotably or hingedly coupled to the arm engagement sections 130.

In various embodiments, each opposable arm 180 includes a support member 190 and a tree engagement member 200. In various embodiments, support member 190 has a first opposing end 210 and second opposing end 220. In various embodiments, first opposing end 210 is pivotably or hingedly coupled to arm engagement section 130. In various embodiments, second opposing end 220 is coupled to tree engagement member 200. In various embodiments, support member 190 includes a first locking feature or notch 230 provided at or about the first opposing end 210 of support member 190. In various embodiments, support member 190 also includes a second locking feature or notch 240 between the first locking feature or features 230 and the second opposing end 220 of support member 190.

In various embodiments, tree engagement member 200 of one opposable arm 180 includes a serrated, jagged, saw-toothed, denticulated, crenelated, irregular or otherwise rough edge 250 on a side of the tree engagement member 200 facing toward base member 110 and/or the other opposable arm 180 when opposable arms 180 are coupled to base member 110. In various embodiments, tree engagement member 200 includes a first edge 260 that extends substantially co-linearly with a longitudinal access of support member 190. In various embodiments, however, tree engagement member 200 extends at an angle to the longitudinal axis of support member 190. For example, as shown in FIG. 1, the tree engagement member 200 of one opposable member 180 may extend toward base member 110 and/or other opposable arm 180 when arms 180 of apparatus are in an open position.

In various embodiments, a firing mechanism or trigger member 270 is coupled to base member 110. In various embodiments, firing mechanism or trigger member 270 is rotatably, hingedly or pivotably coupled to or near arm engagement section 130 of base member 110. In various embodiments, firing mechanism or trigger member 270 is coupled to a tree engagement member 280. In various embodiments, firing mechanism or trigger member 270 includes one or more apertures. In various embodiments, tree engagement member 280 and firing mechanism or trigger member 270 are adjustably coupled by providing screws through the apertures of firing mechanism or trigger member 270 to adjustably retain firing mechanism or trigger member 270 to or relative to tree engagement member 280.

In various embodiments, the firing mechanism or trigger member may be a switch, button, etc., that may be manually activated by the user to cause at least one of the arms to move relative to the other to engage a tree or other structure between the arms.

In various embodiments, tree engagement member 280 is coupled to a first section of firing mechanism or trigger member 270. In various embodiments, a lock member 290 is fastened or otherwise coupled to a second section of firing mechanism or trigger member 230. In various embodiments, lock member 290 includes a lock component 300 adapted to engage the first and/or second locking features 230/240 of an opposable arm 180.

In various embodiments, an actuation member 310 is operatively coupled to opposing arm 180. In various embodiments, actuation member 310 extends between base member 110 and opposable arm 180. In various embodiments, actuation member 310 is operatively coupled at one end to second opposing end 220 of support member 190 and at the other end to tree stand engagement section 120 of base member 110. It should be appreciated, however, that the actuation member may be coupled to the tree engagement member and/or the arm engagement section of the base member. Actuation member 310 is or includes, in various embodiments, a spring such as a tension spring. Various embodiments, however, may make use of a variety of actuation numbers including torsion, tension, compression, leaf, and other types of spring actuation members. In various embodiments, the actuation member may be a motor or other device (e.g., a hydraulic device) for moving the arm relative to the base, the opposing arm, or a tree.

In various embodiments, a tension member 320 may be coupled or operatively coupled at one end to lock member 290 and at another end to base member 110 (e.g., arm engagement section 130 of base member 110). Tension member 320 is or includes, in various embodiments, a spring such as a tension spring. Various embodiments, however, may make use of a variety of actuation numbers including torsion, tension, compression, leaf, and other types of spring actuation members.

In various embodiments, a tertiary locking member 330 is coupled at one end to base member 110, or more specifically, arm engagement section 130. In various embodiments, an opposing end of tertiary locking feature 300 may be releasably coupled to opposable arm 180 to help keep one or more opposable arms 180 releasably locked open and/or apart until a user is ready to utilize the apparatus (e.g., to help hang a tree stand in a tree).

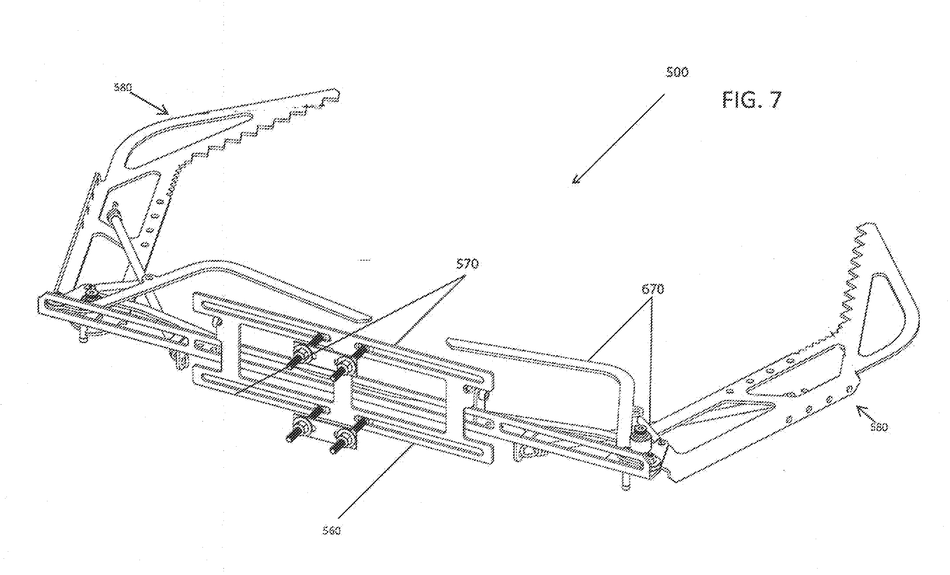

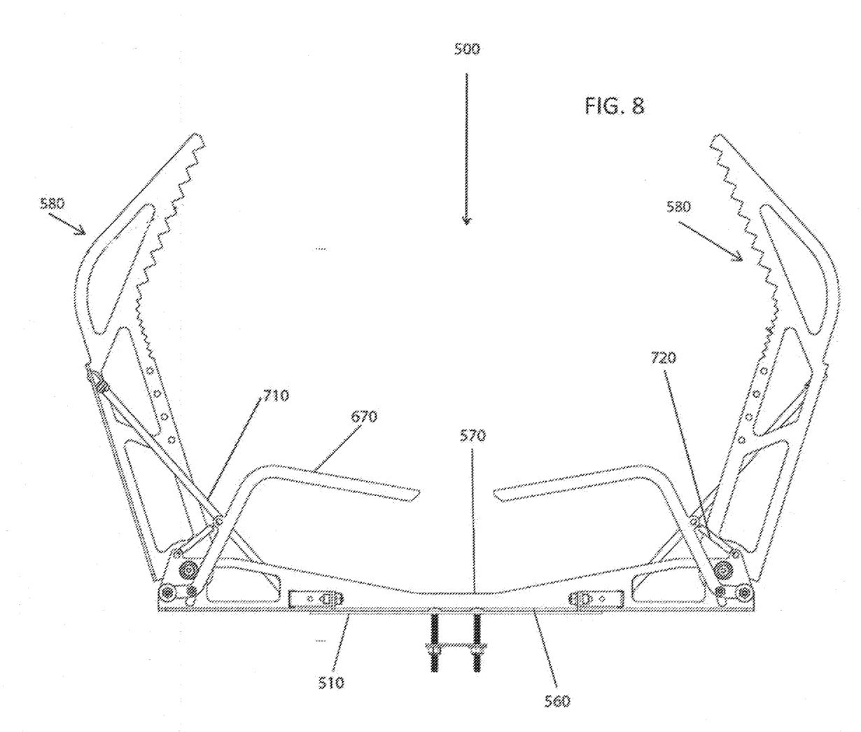

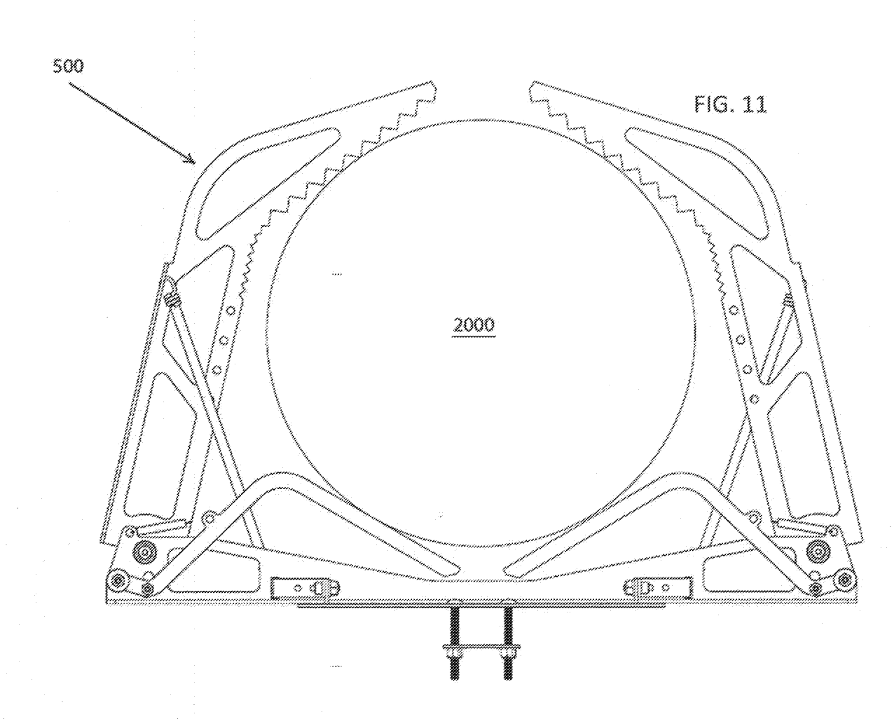

Referring now to FIGS. 7-11, a second embodiment of an assistive apparatus 500 is provided. In various embodiments, assistive apparatus 500 includes a base member 510. In various embodiments, base member 510 includes a tree side surface 560 and a field side surface 570. In various embodiments, tree side surface 560 of base member 510 may be shaped or configured to better and more completely fit rounded perimeter or circumference (e.g., a tree or pole's circumference). In various embodiments, base member 510 is coupled at each end to an opposable arm 580.

In various embodiments, a firing mechanism or trigger member 670 is coupled, or pivotably or hingedly coupled to or near one or more of the opposing ends of base number 510. In various embodiments, an actuation member 710 is operatively coupled and extends between base member 510 and opposable arms 580. In various embodiments, a tension member 720 may be coupled or operatively coupled near one end to the firing mechanism or trigger member 670 and at another end to base member 510 (e.g., an opposing end of base number 510).

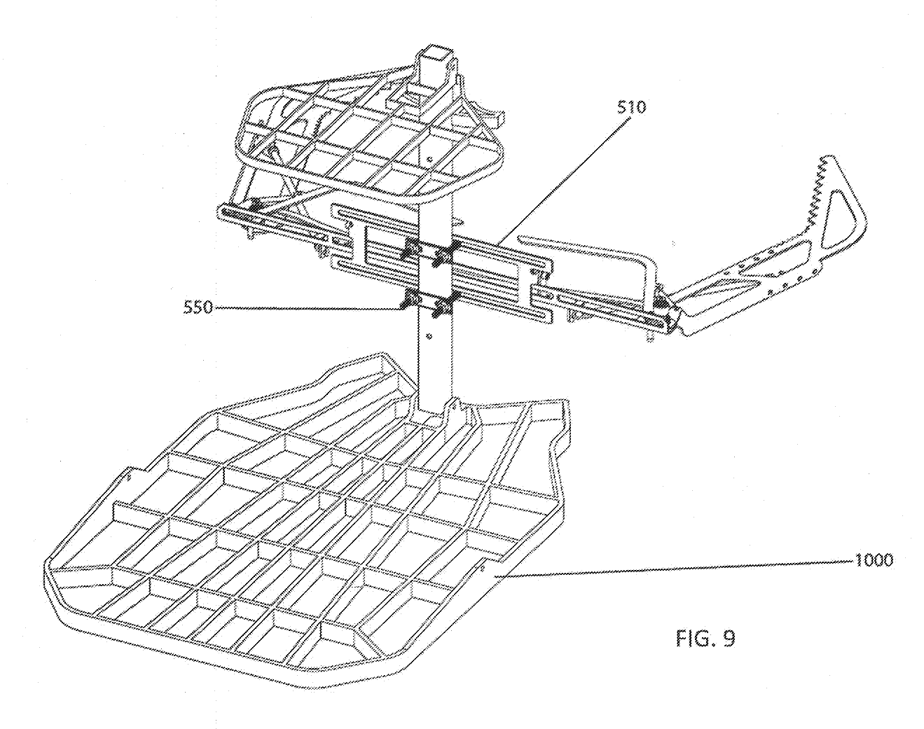

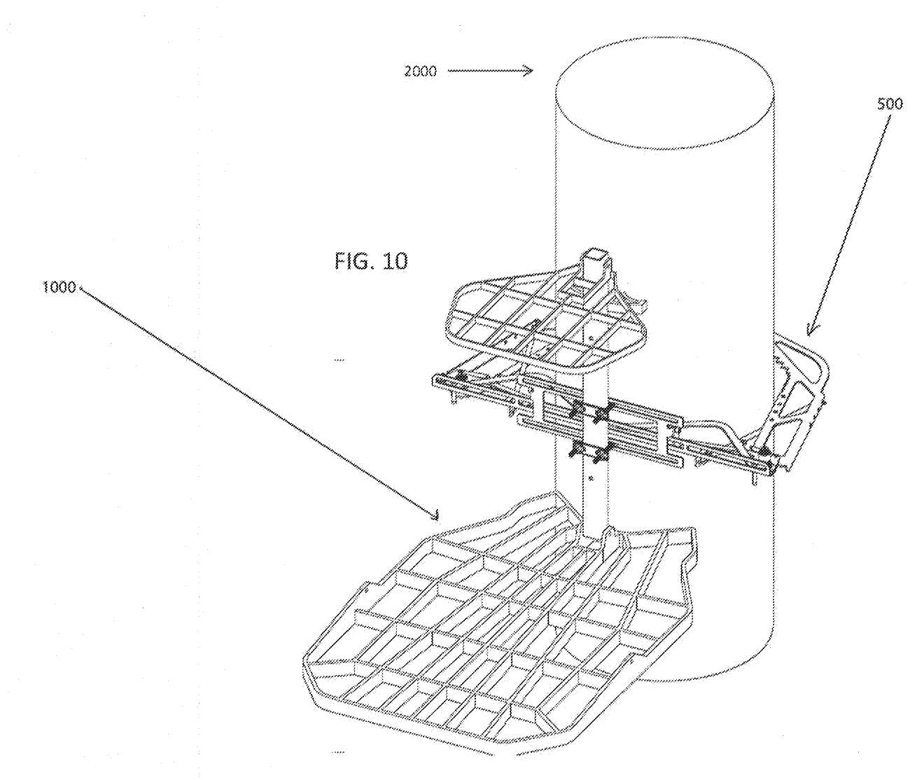

Referring now to FIGS. 9-10, in operation, in various embodiments, a tree stand 1000 is coupled or releasably coupled to the base member of the apparatus (e.g., base member 510 of apparatus 500) (e.g., using adjustable tree stand engagement clamps 550). In various embodiments, the arms of the apparatus are releasably locked in open, spaced apart set positions. In various embodiments, the apparatus (e.g., apparatus 500) is then positioned, oriented and/or provided about a tree 2000 at about the position where tree stand 1000 is intended to be hung on tree 2000. In various embodiments, the tree side surface and/or tree engagement members are moved toward the tree or pole until the tree contacts or engages the tree engagement members operatively coupled to the arms such that the firing mechanism or trigger members pivot relative to the base member or otherwise react to the tree or pole being pushed there against to release the arms from their open, spaced apart positions to closed tree clamping positions.

In various embodiments, the lock component of the lock member may disengage the first locking feature. Once the lock component disengages the first locking feature, in various embodiments, the actuation member contracts, thereby drawing the tree engagement member of the opposable arm into the tree with enough force to retain the apparatus and tree stand relative to the tree.

As shown, the apparatus is designed to help retain relative to a tree or pole the average tree stand which weighs approximately fifteen to twenty-five pounds as well as the apparatus safely in the tree, provided the tree stand is unoccupied. As such, the apparatus holds the tree stand relative to the tree to allow the tree stand to be more easily mounted to the tree. It should be appreciated, however, that the apparatus may be designed and engineered to hold additional weight including an occupied tree stand. Once the tree stand has been mounted to the tree using straps and other mounting features included with the tree stand, the adjustable tree stand engagement clamps may be loosened and the apparatus removed from the tree stand to be used with other tree stands or stored, etc.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. An apparatus for hanging a tree stand, the apparatus comprising:
a base member adapted to be coupled to a tree stand; the base member having a first end and a second end;
a first arm pivotably coupled near the first end of the base member;
an oppositely disposed second arm coupled near the second end base member;
a first actuation member operatively coupled to the base member and the first arm;
a first trigger member pivotably coupled to the base member near the first end of the base member; and
a first lock member coupled to the first trigger member, the first lock member comprising a lock component adapted to engage at least one locking feature of the first arm to help hold the first actuation member in tension as desired.

2. The apparatus of claim 1, further comprising:
a second actuation member operatively coupled to the base member and the second arm;
a second trigger member pivotably coupled to the base member near the second end of the base member; and
a second lock member coupled to the second trigger member, the second lock member comprising a lock component adapted to engage at least one locking feature of the first arm to help hold the second actuation member in tension as desired.

3. The apparatus of claim 1, wherein the first actuation member is a spring.

4. The apparatus of claim 2, wherein the second actuation member is a spring.

5. The apparatus of claim 1, wherein the first arm comprises a serrated edge on a side of the first arm facing toward the second arm.

6. The apparatus of claim 1, wherein the second arm comprises a serrated edge on a side of the second arm facing toward the first arm.

7. The apparatus of claim 1, wherein the first arm comprises a support member and a tree engagement member extending at an angle to the longitudinal axis of the support member.

8. The apparatus of claim 7, wherein the tree engagement member of the first arm extends toward the second arm.

9. The apparatus of claim 1, wherein the second arm comprises a support member and a tree engagement member extending at an angle to the longitudinal axis of the support member.

10. The apparatus of claim 9, wherein the tree engagement member of the second arm extends toward the first arm.

11. An apparatus for hanging a tree stand, the apparatus comprising:
a base member coupled to a means for holding a tree stand; the base member having a first end and a second end;
a first arm pivotably coupled near the first end of the base member;
a second arm coupled near the second end of the base member and oppositely disposed to the first arm;
a means for rotating the first arm relative to the base member and toward the second arm, the means for rotating the first arm being operatively coupled to the first arm; and
a means for triggering the means for rotating the first arm.

12. The apparatus of claim 11, further comprising:
a means for rotating the second arm relative to the base member and toward the first arm, the means for rotating the second arm being operatively coupled to the second arm; and
a means for triggering the means for rotating the second arm.

13. The apparatus of claim 11, wherein the means for rotating the first arm is a spring.

14. The apparatus of claim 12, wherein the means for rotating the second arm is a spring.

15. The apparatus of claim 11, wherein the first arm comprises a serrated edge on a side of the first arm facing the second arm.

16. The apparatus of claim 11, wherein the second arm comprises a serrated edge on a side of the second arm facing the first arm.

17. The apparatus of claim 11, wherein the first arm comprises a support member and a tree engagement member extending at an angle to the longitudinal axis of the support member.

18. The apparatus of claim 17, wherein the tree engagement member of the first arm extends toward the second arm.

19. The apparatus of claim 11, wherein the second arm comprises a support member and a tree engagement member extending at an angle to the longitudinal axis of the support member.

20. The apparatus of claim 19, wherein the tree engagement member of the second arm extends toward the first arm.
